(19) United States
(12) Patent Application Publication
(10) Pub. No.: US 2026/0171321 A1
(43) Pub. Date: Jun. 18, 2026

(54) MULTILAYER CERAMIC ELECTRONIC COMPONENT AND METHOD FOR MANUFACTURING MULTILAYER CERAMIC ELECTRONIC COMPONENTS

(71) Applicant: KYOCERA CORPORATION, Kyoto-Shi, Kyoto (JP)

(72) Inventor: Hisashi SATO, Kirishima-shi (JP)

(73) Assignee: KYOCERA CORPORATION, Kyoto-shi, Kyoto (JP)

(21) Appl. No.: 18/708,038

(22) PCT Filed: Jul. 27, 2022
(86) PCT No.: PCT/JP2022/028992

§ 371 Date: May 7, 2024

(30) Foreign Application Priority Data
Nov. 19, 2021 (JP) 2021-188956

(51) Int. Cl. H01G 4/30; H01G 4/012; H01G 4/232

(52) U.S. Cl. CPC H01G 4/30; H01G 4/012; H01G 4/2325

(57) ABSTRACT

A method for manufacturing multilayer ceramic electronic components includes stacking a plurality of ceramic green sheets and a plurality of internal electrodes alternately on one another, obtaining a multilayer base including an electrode pattern protected by a resin layer on at least one of main surfaces of the stack, cutting the multilayer base along a cutting line perpendicular to the multilayer base to obtain base components being rectangular, removing the resin layer in each base precursor by firing, and chamfering an edge of each base component before firing.

### TECHNICAL FIELD

The present disclosure relates to a multilayer ceramic electronic component and a method for manufacturing multilayer ceramic electronic components.

### BACKGROUND OF INVENTION

Known multilayer ceramic electronic components and methods for manufacturing the multilayer ceramic electronic components are described in, for example, Patent Literatures 1 and 2.

### CITATION LIST

### Patent Literature

Patent Literature 1: Japanese U.S. Pat. No. 5,535,765
Patent Literature 2: Japanese U.S. Pat. No. 4,425,688

### SUMMARY

In an aspect of the present disclosure, a multilayer ceramic electronic component includes a stack including dielectric layers and internal electrodes alternately stacked on one another, a surface electrode located on at least one of a first surface or a second surface of the stack, and an external electrode connecting the surface electrode and the internal electrodes. The surface electrode is thicker than each of the internal electrodes, and located continuously with a uniform thickness along at least one of the first surface or the second surface of the stack.

In an aspect of the present disclosure, a method for manufacturing multilayer ceramic electronic components includes stacking a plurality of ceramic green sheets and a plurality of internal electrodes alternately on one another to obtain a stack, obtaining a multilayer base including a surface electrode and a resin layer protecting the surface electrode on at least one of a first surface or a second surface of the stack, cutting the multilayer base along a cutting line perpendicular to the multilayer base to obtain base precursors being rectangular, removing the resin layer in each of the base precursors by firing, and chamfering an edge of each of the base precursors before firing.

### BRIEF DESCRIPTION OF THE DRAWINGS

The objects, features, and advantages of the present disclosure will become more apparent from the following detailed description and the drawings.

FIG. 1 is a perspective view of a via array capacitor as a multilayer ceramic electronic component according to one embodiment of the present disclosure.

FIG. 2 is a schematic exploded perspective view of stacked sheets on some of which a conductive paste is printed.

FIG. 3 is a perspective view of a multilayer base of via array capacitors.

FIG. 4A is a cross-sectional view of a base precursor of the via array capacitor taken along the center line of each feedthrough conductor.

FIG. 4B is a cross-sectional view of the base precursor after barrel polishing.

FIG. 4C is a cross-sectional view of a base component after firing.

FIG. 5A is a perspective view of a typical multilayer ceramic capacitor.

FIG. 5B is a perspective view of a multilayer ceramic capacitor referred to as a three-terminal capacitor.

FIG. 6A is a perspective view of the base component of the capacitor in FIG. 5A yet to include external electrodes formed by direct plating.

FIG. 6B is a perspective view of the base component of the capacitor in FIG. 5B yet to include external electrodes formed by direct plating.

FIG. 7 is a schematic exploded perspective view of stacked ceramic green sheets on some of which internal electrodes are printed, illustrating a structure corresponding to one component.

FIG. 8 is a perspective view of a multilayer base.

FIG. 9 is a perspective view of a base precursor cut from the multilayer base.

FIG. 10A is a cross-sectional view of the base precursor in FIG. 9 taken along line A-A'.

FIG. 10B is a cross-sectional view of the base precursor after barrel polishing.

FIG. 10C is a cross-sectional view of a base component after firing.

### DESCRIPTION OF EMBODIMENTS

A multilayer ceramic electronic component and a method for manufacturing multilayer ceramic electronic components with the structure that forms the basis of a multilayer ceramic electronic component and a method for manufacturing multilayer ceramic electronic components according to one or more embodiments of the present disclosure will be described first.

With the multilayer ceramic electronic component and the method for manufacturing multilayer ceramic electronic components with the structure that forms the basis of the multilayer electronic component according to one or more embodiments of the present disclosure, electronic components mounted on a wiring board of electronic devices have been miniaturized. Some multilayer ceramic electronic components incorporating internal electrodes include electrode pads and electronic circuits on their main surfaces. Such surface electrodes are formed on the main surfaces by, for example, printing, vapor deposition, or immersing after chamfering. Chamfering is performed before formation of the surface electrodes to avoid damage on the formed surface electrodes resulting from chamfering such as barreling or sandblasting that performs polishing in a rotary pot with abrasives. However, smaller components have more difficulty in forming electrode patterns with high accuracy. Thus, some methods have been developed.

For example, Patent Literature 1 describes chamfering with grooves formed on a surface of a multilayer base with laser along the outlines of product areas. The multilayer base is a stack of integrated internal electrodes and ceramic green sheets with surface electrodes. Break grooves are then formed, and the multilayer base is broken into individual products after firing. The surface electrodes can be formed on the main surface of the chamfered multilayer base before breaking. This allows formation of electrodes with high positional accuracy.

For example, Patent Literature 2 describes anchor tabs located between dielectric layers close to a main surface to allow formation of external electrodes by direct plating on a chamfered base component being a body of a multilayer ceramic electronic component. The intervals between the exposed portions of the anchor tabs are smaller toward the top surface and the bottom surface. The external electrodes formed on such a structure by direct plating can have high bonding with internal electrodes with less misalignment, allowing the external electrodes to be formed with high resolution and high accuracy. The external electrodes can be formed at rounded corners with high plating reliability.

However, the method described in Patent Literature 1 forms the grooves for chamfering on the multilayer base with laser. This increases work-hours and costs as compared with barrel polishing for mass chamfering performed with other known techniques. This can be a burden on manufacturing.

With the method described in Patent Literature 2, the intervals between the exposed portions of adjacent anchor tabs are smaller toward the top surface and the bottom surface. This involves preparation of ceramic green sheets with various thicknesses on which the anchor tabs are located. The anchor tabs are dummy electrodes not associated with capacitance formation. The exposed portions of the anchor tabs serve as plating growth starting points for forming a plating film to be an external electrode. The anchor tabs also fix the plating film to the ceramic body.

In response to the above, one or more aspects of the present disclosure are directed to a multilayer ceramic electronic component and a method for manufacturing multilayer ceramic components that facilitate chamfering without damaging electrodes on the main surface.

The multilayer ceramic electronic component and the method for manufacturing multilayer ceramic electronic components according to one or more embodiments of the present disclosure will now be described with reference to the drawings using multilayer ceramic capacitors each as an example of the multilayer ceramic electronic component. The multilayer ceramic electronic component according to one or more embodiments of the present disclosure is not limited to the multilayer ceramic capacitor, and may be any of other electronic components including surface electrodes on their main surfaces, such as multilayer piezoelectric elements, multilayer thermistor elements, multilayer chip coils, and multilayer ceramic substrates.

### First Embodiment

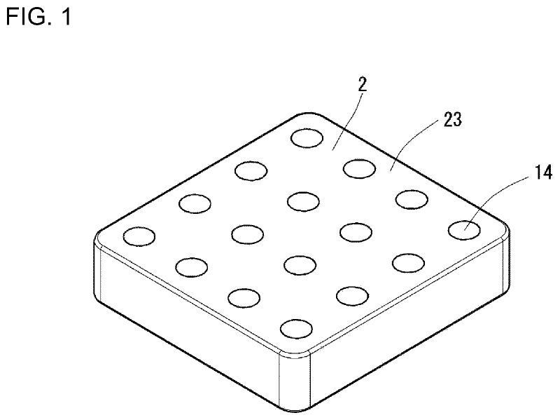

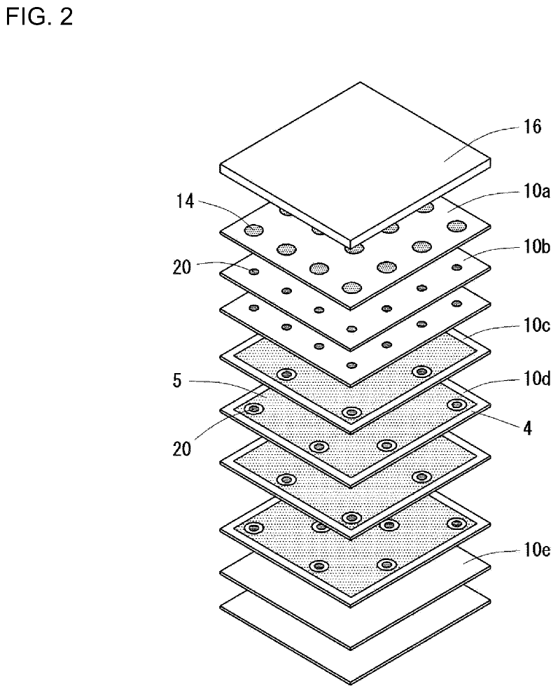

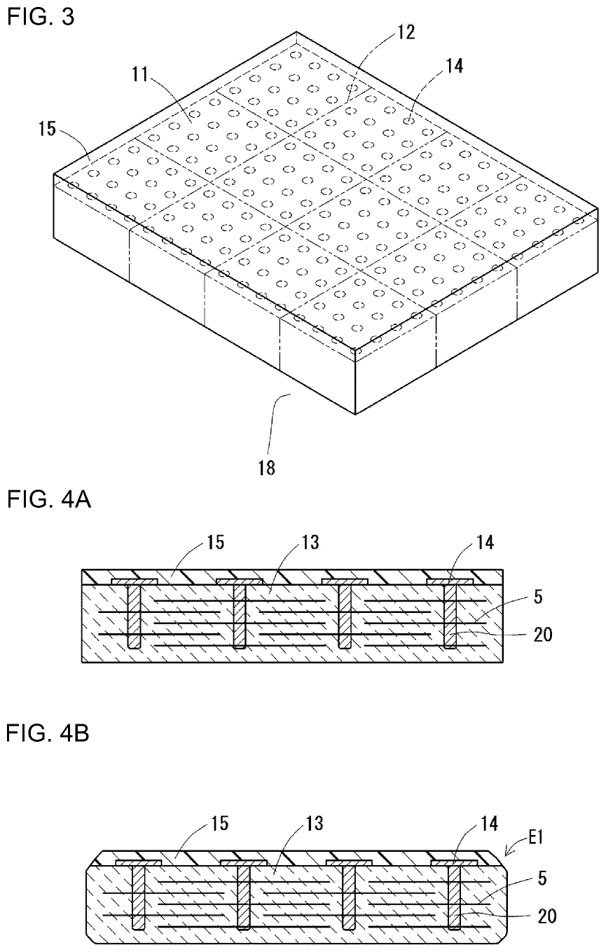

FIG. 1 is a perspective view of a via array capacitor 23 as a multilayer ceramic electronic component according to one embodiment of the present disclosure, located closest to a large-scale integration (LSI) circuit on a circuit board. FIG. 2 is a schematic exploded perspective view of stacked sheets on some of which a conductive paste is printed. FIG. 3 is a perspective view of a multilayer base 11 of via array capacitor 23. The capacitor of this type reduces inductance and allows high-speed power supply to LSI circuits. In a first embodiment below, the multilayer ceramic electronic component will be described using the via array capacitor 23 as an example.

In the present embodiment, the via array capacitor 23 includes a stack including dielectric ceramic bodies 4 as dielectric layers and internal electrodes 5 alternately stacked on one another, surface electrodes 14 including an electrode film located on the two ends of each of a first surface and a second surface of the stack, and feedthrough conductors 20 connecting the surface electrodes 14 and the internal electrodes 5. The surface electrodes 14 are thicker than the internal electrodes 5 and located continuously with a uniform thickness along at least one of the first surface or the second surface of the stack.

The surface electrodes 14 and the internal electrodes 5 may each contain a ceramic component. The surface electrodes 14 may contain greater amounts of ceramic component than the internal electrodes 5. Each internal electrode 5 is fixed between dielectric layers whereas the surface electrodes 14 adhere to the first surface and the second surface of the stack with the ceramic component of the surface electrodes 14 mixing into the main surfaces in solid state.

The surface electrodes 14 and the internal electrodes 5 may each contain a glass component. The surface electrodes 14 may contain greater amounts of glass component than the internal electrodes 5.

The surface electrodes 14 thicker than the internal electrodes 5 can be at least as conductive as the internal electrodes 5, although the surface electrodes 14 contain greater amounts of ceramic or glass component than the internal electrodes 5. Each surface electrode 14 is to have a thickness at least greater than a value obtained by multiplying the inverse of the volume percentage of the metal component in the surface electrodes 14. However, the actual thickness greatly changes based on the space structure of the metal component and the other components. The thickness may thus be greater than or equal to three times the value.

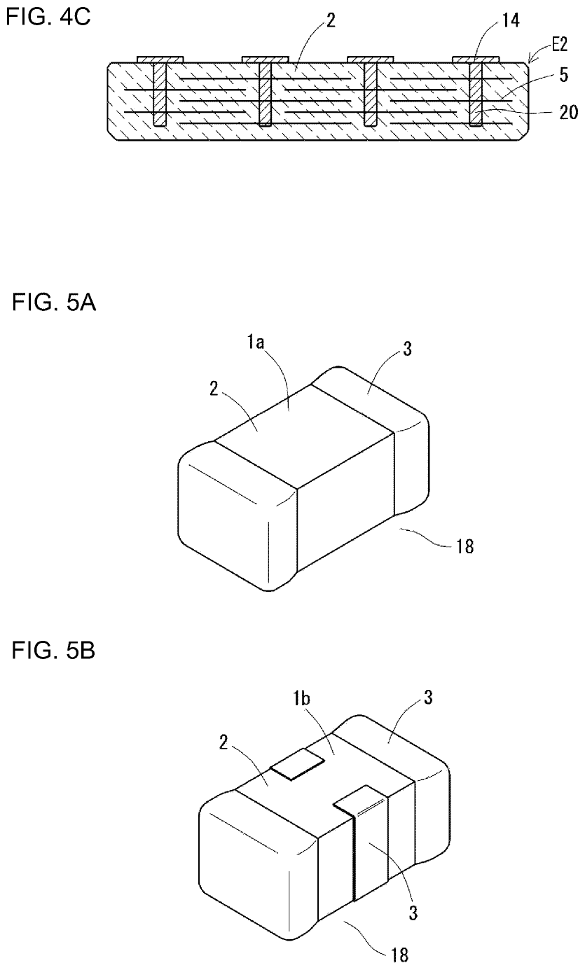

As illustrated in the cross-sectional view in FIG. 4C, the via array capacitor 23 includes, on its first surface and second surface, multiple surface electrodes 14 with different polarities arrayed in a staggered manner. Each surface electrode 14 is connected to the corresponding internal electrodes 5 serving as an internal capacitor with the corresponding feedthrough conductor 20. The outer edges and corners E1 of the rectangular plate are chamfered by, for example, barrel polishing or sandblasting. Chamfered surfaces E2 appear after chamfering, reducing chipping or microcracks specific to ceramic. This allows smooth product handling with, for example, a parts feeder.

In the first embodiment, the method for manufacturing multilayer ceramic electronic components includes stacking multiple ceramic green sheets 10 and the multiple internal electrodes 5 including the feedthrough conductors 20 alternately stacked on one another to form a stack, forming the surface electrodes 14 onto at least one of the first surface or the second surface of the stack to obtain a multilayer base 11 (refer to FIG. 3) including a resin layer 15 protecting the surface electrodes 14, cutting the multilayer base 11 along cutting lines 12 perpendicular to the multilayer base 11 to obtain rectangular base precursors 13, removing the resin layer 15 on each base precursor 13 by firing, and chamfering the edges of each base precursor 13 before firing.

The resin layer 15 is formed from a resin sheet 16. The resin sheet 16 is stacked on at least one of the first surface or the second surface of the stack together with the surface electrodes 14 when the ceramic green sheets are stacked.

Barrell polishing, which is a typical method for chamfering ceramic chip components, allows simple chamfering at high production efficiency. However, barrel polishing can polish surfaces of base components 2 in addition to corners and edges. Thus, the surface electrodes 14 are attached after chamfering in known techniques. Smaller components thus have more difficulty in attaching external electrodes 3 (refer to FIGS. 5A and 5B) at accurate positions on the first surface and the second surface. A process of forming the surface electrodes 14 onto the multilayer base 11 yet to be cut into individual base components 2 and then performing chamfering without damaging the formed surface electrodes 14 will now be described in detail.

A ceramic mixture powder containing a ceramic dielectric material of BaTiO₃ with an additive is first wet-milled and blended using a bead mill. A polyvinyl butyral binder, a plasticizer, and an organic solvent are added to this milled and blended slurry and are mixed together to prepare ceramic slurry.

A die coater is then used to shape ceramic green sheets 10a to 10e (collectively referred to as ceramic green sheets 10 without letters a to e) on a carrier film. Each ceramic green sheet 10 may have a thickness of, for example, about 1 to 10 μm. Thinner ceramic green sheets 10 can increase the capacitance of the multilayer ceramic capacitor. The ceramic green sheets 10 may not be shaped by die coating, but may be shaped by, for example, doctor blading or graphic coating.

The resin sheet 16 is prepared separately. The resin sheet 16 may have a thickness of, for example, about 10 to 50 μm. The resin sheet 16 serves as a protective layer during barrel polishing. A thinner resin sheet 16 does not achieve the intended function during barrel polishing. A thicker resin sheet 16 can increase the material cost. The resin sheet 16 described above is attached onto the surface of the stack including the ceramic green sheets 10 and the internal electrodes 5 and serves as the protective layer as illustrated in FIG. 4B. The protective layer is burned away in the subsequent firing process, as illustrated in FIG. 4C. The resin sheet 16 is a thermoplastic resin, such as polyethylene, polypropylene, polystyrene, acrylonitrile styrene, a methacrylic resin, polyethylene terephthalate, polyvinyl alcohol, a polyurethane resin, a polyethylene oxide resin, or methacrylic acid ester polymers.

The glass transition temperature of the resin in the resin sheet 16 greatly varies with, for example, the molecular weight and the acetyl group in the resin, although the resin is of the same type. The resin sheet 16 may include a resin having the glass transition temperature close to that of the entire resin including, for example, the binder and the plasticizer contained in the ceramic green sheets 10. In this case, the resin layer 15 including the resin sheet 16 has the thermoplastic property similar to that of the ceramic green sheets 10. This allows the resulting stack to have less internal deformation in the subsequent stack-pressing process performed. The resin having a thermal decomposition temperature lower than or equal to the thermal decomposition temperature of the binder contained in the ceramic green sheets 10 and the internal electrodes 5 is less likely to affect the firing profile in the subsequent firing process for the base precursors 13. The resin layer 15 may be free of, for example, chlorine or fluorine. Such a resin can reduce the likelihood that a substance such as chlorine or fluorine remains on the surface of the base component 2 after firing the base precursor 13 and causes characteristic deterioration in the products.

The ceramic green sheets 10 including through-holes are then prepared. The through-holes are each formed at the center of the corresponding feedthrough conductor 20 illustrated in FIG. 2. FIG. 2 is a schematic diagram corresponding to a single base component. In this state in which drilling is performed, each ceramic green sheet 10 is drilled before the multilayer base 11 is cut into the base precursors 13 of the individual base components 2. Each through-hole may have a diameter of about 30 to 1500 μm and may be formed with a drill, a punch, or by laser processing.

The prepared ceramic green sheets 10 including the through-holes may be formed by printing, in a predetermined pattern, a conductive paste to be the internal electrodes 5 and the surface electrodes 14 on blank ceramic green sheets 10 and the resin sheet 16.

The conductive paste may be printed by, for example, screen printing or gravure printing. The conductive paste may contain a metal such as Ni, Pd, Cu, or Ag or an alloy of these metals. The conductive paste for the surface electrodes 14 may be mixed with a ceramic powder or a glass powder in addition to the above metal powder to increase the bonding with the ceramic base during firing. The conductive paste as a common material may be, for example, a nickel paste mainly containing a nickel powder and containing a barium titanate powder.

The printing pattern of the conductive paste to be the internal electrodes 5 and the surface electrodes 14 will be briefly described with reference to the exploded perspective view in FIG. 2 illustrating a stacked state for one component. The conductive paste for the surface electrodes 14 is printed on the ceramic green sheet 10a. The ceramic green sheet 10b includes multiple through-holes, which are filled with the conductive paste. The internal electrodes 5 for two different polarities are printed on the ceramic green sheets 10c and 10d. In printing the internal electrodes 5, the through-holes are filled with the internal electrodes 5. The conductive paste for the surface electrodes 14 is printed on the resin sheet 16.

Thinner internal electrodes 5 can reduce internal defects resulting from internal stress. For a capacitor with a stack of many layers, the internal electrodes 5 may each have, for example, a thickness of 1.0 μm or less.

After printing the internal electrodes 5, the ceramic green sheets 10 with the printed conductive paste are stacked in the order illustrated in FIG. 2. First, a predetermined number of blank ceramic green sheets 10e to be a cover layer are placed on one another to obtain a stack, on which a predetermined number of ceramic green sheets 10c and 10d with the internal electrodes 5 printed for two different polarities are alternately stacked on one another, a predetermined number of ceramic green sheets 10b with the printed feedthrough conductors 20, and then the ceramic green sheet 10a with the printed surface electrodes 14 are stacked, and a blank resin sheet 16 is finally placed. The ceramic green sheets 10 are stacked on a support sheet 18. The support sheet 18 may be an adhesive releasable sheet that is adhesive and releasable, such as a low-tack sheet or a foam releasable sheet.

FIG. 3 is a perspective view of the multilayer base 11 being the stack described above that is press-bonded in the stacking direction to be a single piece. The resin layer 15 is semitransparent and allows the surface electrodes 14 on the main surface to be seen through. In the multilayer base 11, the conductive paste pre-placed in the through-holes in the ceramic green sheets 10 joins to be the feedthrough conductors 20 connecting the internal electrodes 5 and the surface electrodes 14. The support sheet 18, which is used in stacking the ceramic green sheets 10, is located under the multilayer base 11. In FIG. 3, the grid imaginary lines illustrated on the main surface are cutting lines 12 indicating the positions for cutting. The imaginary line on the side surfaces and parallel to the main surface is the boundary between the resin layer 15 and the ceramic layer.

As illustrated in FIGS. 4A to 4C, the feedthrough conductors 20 may be formed by filling, with the conductive paste, through-holes formed by drilling, punching, or applying laser after the ceramic green sheets 10 are stacked to be the multilayer base 11. The resin sheet 16 may then be placed on a surface of the multilayer base 11. The surface electrodes 14 may be located on the first surface and the second surface for the intended component performance. In this case, the resin sheet 16 is attached to both the first surface and the second surface. The resin sheet 16 may be thermally press-bonded to the first surface and the second surface.

The multilayer base 11 is then cut along the cutting lines 12 into individual base precursors 13. FIG. 4A is a cross-sectional view of a cut base precursor 13 taken along the center line of each feedthrough conductor 20. The feedthrough conductors 20 connect the internal electrodes 5 and the surface electrodes 14 with the same polarity. The surface resin layer 15 protects the surface electrodes 14.

The base precursor 13 in FIG. 4A is then chamfered by barreling. In the barreling, multiple unfired base precursors 13 are placed into a rotary pot together with abrasives such as a ceramic powder and resin beads, and undergo wet-barrel polishing in water. Base precursors 13 to avoid water may be chamfered by dry-barrel polishing using no water.

FIG. 4B is a cross-sectional view of the base precursor 13 after barrel polishing. All the edges and apexes are rounded. Although not illustrated, the surfaces are also polished. The surface layers of the six faces are ground by a predetermined amount and removed. The first surface and the second surface with the protective resin layers 15 maintain the surface electrodes 14 at the states before the barreling. The four sides of each surface of the ceramic green sheets 10 in contact with the resin layer 15 are chamfered to have no burrs or corners as indicated by reference numeral E1.

The chamfered base precursors 13 are then degreased and fired in the firing process. The base precursors 13 are degreased in a furnace with a nitrogen atmosphere by increasing the temperature to 700° C., and then fired in a reducing furnace with a hydrogen atmosphere at peak temperatures of 1100 to 1250° C. to be sintered base components 2.

FIG. 4C is a cross-sectional view of a base component 2 after firing. The resin layer 15 on the base precursor 13 is burned away in the firing process. The base component 2 thus includes a sintered ceramic portion alone. The base component 2 includes the four sides of each of the first surface and the second surface chamfered by a predetermined amount in the barreling performed before the firing, and have no burrs and sharp corners as indicated by reference numeral E2.

To facilitate mounting by soldering, the surface electrodes 14 of the base components 2 after firing may be plated with a single layer or multiple layers. The plated surface electrodes 14 may further be plated to allow projection conductors to be formed on the surface electrodes 14.

As described in the first embodiment, chamfering is performed with the surface electrodes 14 pre-formed on the unfired multilayer base 11 and covered by the resin layer 15. This allows accurate formation of the small surface electrodes 14 compared with known techniques for forming the surface electrodes 14 on the fired individual base components 2. This also allows use of known barreling and eliminates attaching the surface electrodes 14 to the individual base components 2 in a later process, thus reducing the number of manufacturing processes and manufacturing costs.

### Second Embodiment

A second embodiment will now be described. Like reference numerals denote the components corresponding to those in the above first embodiment. FIG. 5A is a perspective view of a typical multilayer ceramic capacitor 1a. FIG. 5B is a perspective view of a multilayer ceramic capacitor 1b referred to as a three-terminal capacitor. Each capacitor includes a substantially rectangular base component 2 and external electrodes 3. The external electrodes 3 connected to partially exposed internal electrodes 5 are located on a pair of end faces 8 or a pair of side surfaces 9 of the base component 2 and extend to other adjacent surfaces.

The external electrodes 3 each typically include an underlying electrode and a plated outer layer. The underlying electrode is formed by applying a conductive paste to the base component 2 and baking the paste at high temperatures for metallization. The plated outer layer is attached onto the underlying electrode. With the reduction in thickness of the external electrodes 3 resulting from miniaturization of the components, some known products may eliminate metalized underlying electrodes and include external electrodes 3 formed by directly plating the base components 2.

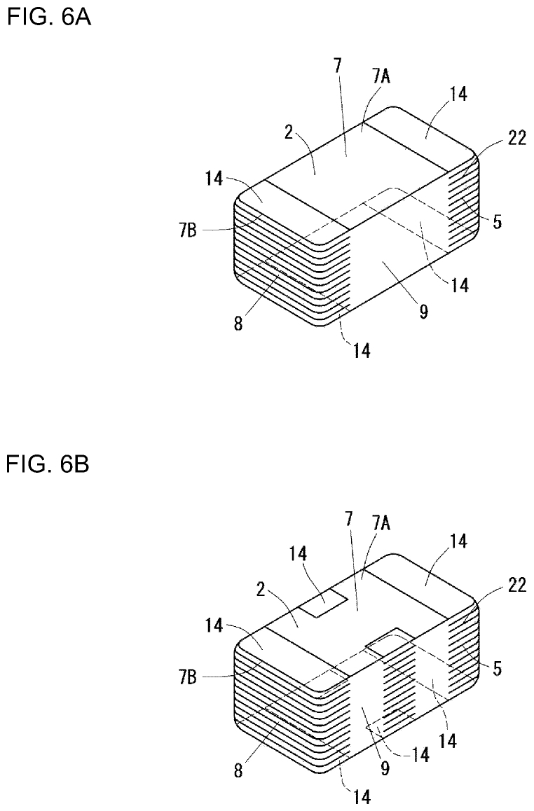

FIG. 6A is a perspective view of the base component 2 of the capacitor in FIG. 5A yet to include the external electrodes 3 formed by direct plating. FIG. 6B is a perspective view of the base component 2 of the capacitor in FIG. 5B yet to include the external electrodes 3 formed by direct plating. Each base component 2 includes surface electrodes 14 on its first surface 7A and second surface 7B, with internal electrodes 5 partially exposed on the first surface 7A and the second surface 7B or the side surfaces 9. When such a base component 2 is plated, the plating grows from the exposed portions of the internal electrodes 5 on the end faces 8 or the side surfaces 9. Adjacent portions of the plating join to one another to be a plating film. The plating film also joins with a plating film on the surface electrodes 14 to be a continuous plating film. This allows manufacturing the products including the external electrodes 3 that are the same as or similar to the external electrodes 3 in FIGS. 5A and 5B.

The surface electrodes 14 are thicker than the internal electrodes 5, and located continuously with a uniform thickness along at least one of the first surface 7A or the second surfaces 7B of the stack.

The surface electrodes 14 and the internal electrodes 5 may each contain a ceramic component. The surface electrodes 14 may contain greater amounts of ceramic component than the internal electrodes 5. Each internal electrode 5 is fixed between dielectric layers whereas the surface electrodes 14 adhere to the first surface 7A and the second surface 7B with the ceramic component of the surface electrode 14 mixing into the first surface 7A and the second surface 7B in solid state.

The surface electrodes 14 and the internal electrodes 5 may each contain a glass component. The surface electrodes 14 may contain greater amounts of glass component than the internal electrodes 5. Each internal electrode 5 is fixed between dielectric layers whereas the surface electrodes 14 adhere to the main surfaces with the glass component of the surface electrodes 14 mixing into the main surfaces in solid state.

The surface electrodes 14 thicker than the internal electrodes 5 can be at least as conductive as the internal electrodes 5, although the surface electrodes 14 contain greater amounts of ceramic or glass component than the internal electrodes 5. Each surface electrode 14 is to have a thickness at least greater than a value obtained by multiplying the inverse of the volume percentage of the metal component in the surface electrodes 14. However, the actual thickness greatly changes based on the space structure of the metal component and the other components. The thickness may thus be greater than or equal to three times the value.

The internal electrodes 5 located closest to the resin layer 15 in the multilayer base 11 are anchor tabs 22. The exposed portions of the anchor tabs 22 on the side surfaces, the exposed portions of the other internal electrodes 5, and the ends of the surface electrodes 14 are aligned in the stacking direction. The surface electrodes 14 covered by the resin layers 15 in the base precursor 13 have predetermined electrode patterns and include the external electrodes 3 connecting the internal electrodes 5 and the electrode patterns of the surface electrodes 14.

In the second embodiment, a method for manufacturing the multilayer ceramic capacitors 1a includes stacking multiple ceramic green sheets 10 and multiple internal electrodes 5 alternately on one another to form a stack, forming the surface electrodes 14 onto at least one of the first surface or the second surface of the stack to obtain the multilayer base 11 including the resin layers 15 protecting the surface electrodes 14, cutting the multilayer base 11 along cutting lines 12 perpendicular to the multilayer base 11 to obtain rectangular base precursors 13, removing the resin layers 15 in the base precursors 13 by firing, and chamfering the edges of the base precursors 13 before firing.

The resin layers 15 is formed from the resin sheet 16. The resin sheet 16 is stacked on at least one of the first surface 7A or the second surface 7B of the stack together with the surface electrodes 14 when the ceramic green sheets 10 are stacked. The surface electrodes 14 may be formed on the resin sheet 16.

In the second embodiment described below, a method for manufacturing the base components 2 in FIG. 6A will be described.

Raw material slurry is first prepared and shaped into ceramic green sheets 10. The ceramic green sheets 10 are prepared in the same or similar manner as in the first embodiment, and will not be described repeatedly. Each ceramic green sheet 10 may have a thickness less than or equal to 10 μm. When the external electrodes 3 are formed by directly plating each base component 2, the plating grows from the layer ends of the internal electrodes 5 exposed on the side surfaces 9 of the base component 2 and joins with plating growing from the layer ends of adjacent internal electrodes 5 to be a plating film. Thus, the internal electrodes 5 located at intervals greater than or equal to 10 μm may cause the plating film to be discontinuous.

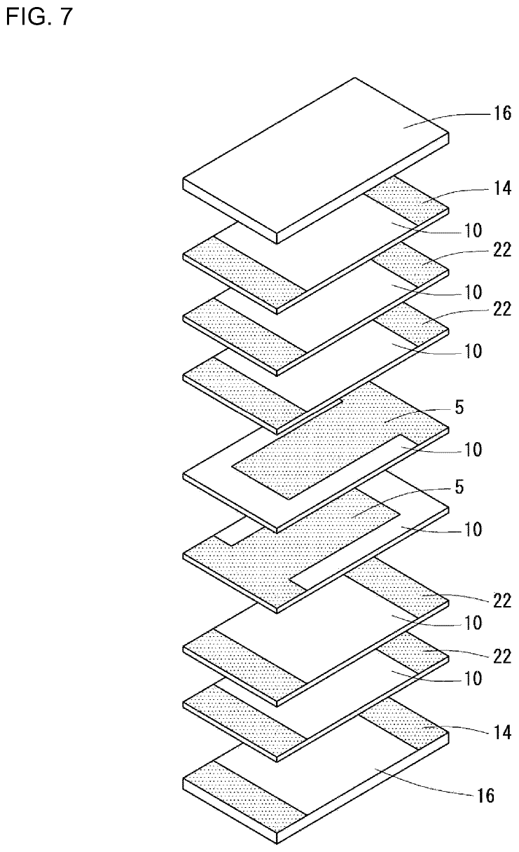

A conductive paste for the internal electrodes 5 and a conductive paste for the surface electrodes 14 are prepared. The details are the same as or similar to in the first embodiment, and will not be described repeatedly. The conductive paste for the anchor tabs 22 (refer to FIG. 7) used in the second embodiment may contain a metal such as Ni, Pd, Cu, or Ag or an alloy of these metals. The conductive paste for the anchor tabs 22 may be the same as the conductive paste for the internal electrodes 5. These conductive pastes are printed on the ceramic green sheets 10 in a predetermined pattern with a printing method such as screen printing or gravure printing.

The resin sheets 16 are prepared separately. The resin sheets 16 may have a thickness of, for example, about 10 to 100 μm. The material and the characteristics of the resin sheets 16 are the same as in the first embodiment. The resin sheets 16 are used to protect the electrodes on the first surface and the second surface of the base components 2 from damage and foreign substances during chamfering.

Some of the resin sheets 16 have the pattern of the surface electrodes 14 printed with the conductive paste. The surface electrodes 14 printed on the resin sheets 16 are pressed against the press-bonded stack of the ceramic green sheets 10 and are fired with no additional process. The resin sheets 16 are then burned away, allowing the surface electrodes 14 to remain on the base component 2 that is a ceramic fired body.

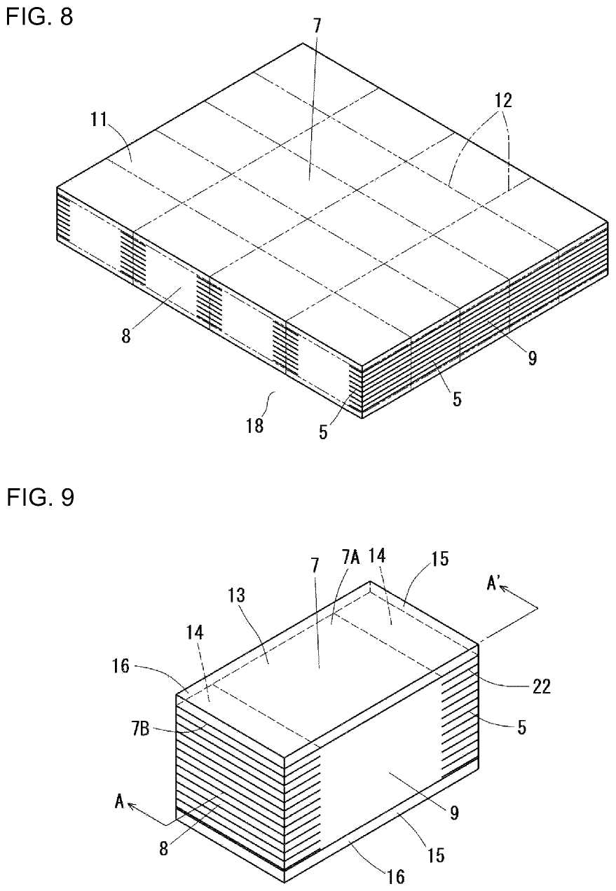

FIG. 7 is a schematic exploded perspective view of the stacked ceramic green sheets 10 on some of which the internal electrodes 5 are printed, illustrating a structure corresponding to one component. A resin sheet 16 with the printed surface electrodes 14 is placed on a support sheet 18 (refer to FIG. 8), on which a predetermined number of ceramic green sheets 10 with the printed anchor tabs 22, ceramic green sheets 10 including a predetermined number of sets of two different internal electrodes 5 alternately stacked on one another, a predetermined number of ceramic green sheets 10 with the printed anchor tabs 22, and a ceramic green sheet 10 with the printed surface electrodes 14 are placed in this order, and a blank resin sheet 16 is finally placed. The support sheet 18 described above may be an adhesive releasable sheet that is adhesive and releasable, such as a low-tack sheet with less adhesive force or a foam releasable sheet.

The stack is then press-bonded to be the multilayer base 11 being a single piece as illustrated in FIG. 8. The multilayer base 11 may be pressed using, for example, a hydrostatic press device. The ceramic green sheets 10 may be heated during pressing to accelerate bonding. Imaginary lines 12 in FIG. 8 are cutting lines indicating the positions for cutting. The support sheet 18, which is used in stacking the ceramic green sheets 10, is located under the multilayer base 11.

Subsequently, the multilayer base 11 is cut along the cutting lines 12 into predetermined dimensions using a press-cutting device to obtain the base precursors 13 in FIG. 9. The multilayer base 11 may be cut with any device other than a press-cutting device. For example, a dicing saw may be used. The first surface, the second surface, the end faces, and the side surfaces of the multilayer base 11, corresponding respectively to the first surface 7A, the second surface 7B, the end faces 8, and the side surfaces 9 of the base precursor 13, are hereafter denoted with the same reference numerals.

In FIG. 9, although the semitransparent resin layers 15 allow the surface electrodes 14 to be seen through, the surface electrodes 14 are protected by the resin layers 15. The internal electrodes 5, the anchor tabs 22, and the surface electrodes 14 illustrated in FIG. 7 are partially exposed on the end faces 8 and the side surfaces 9 in an aligned manner. The external electrodes 3 are formed by direct plating. The external electrodes 3 are thus formed in the area in which the components are aligned.

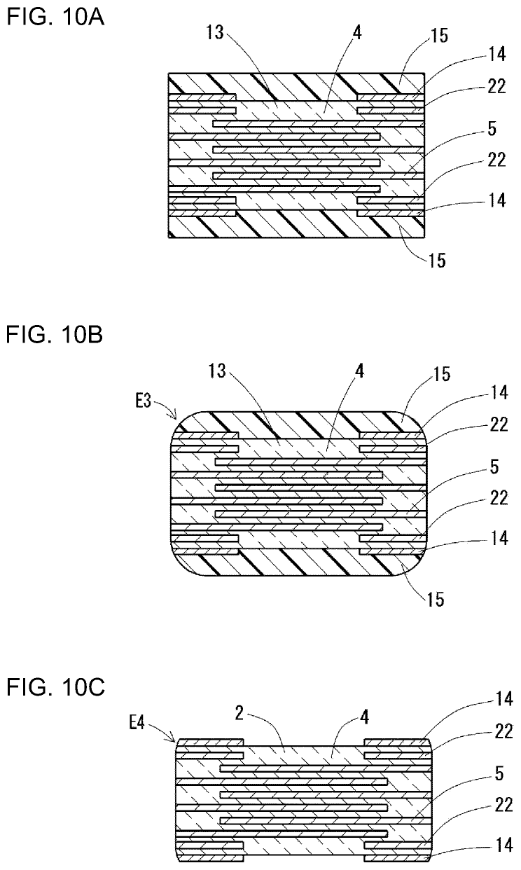

FIG. 10A is a cross-sectional view of the base precursor 13 in FIG. 9 taken along line A-A′. The surface electrodes 14 are protected by the resin layers 15 on the first surface and the second surface.

Chamfering is then performed by barreling. In the barreling, multiple base precursors 13 are placed into a rotary pot together with abrasives such as a ceramic powder and resin beads or with a lubricant, and undergo wet-barrel polishing in water. Base components to avoid water may be chamfered by dry-barrel polishing using no water.

FIG. 10B is a cross-sectional view of the base precursor 13 after barrel polishing. As indicated by reference numeral E3, all the edges and apexes are rounded. Although not illustrated, all the surfaces are polished. The surface layers of the six faces are ground by a predetermined amount and removed. The first surface 7A and the second surface 7B with the protective resin layers 15 maintain the surface electrodes 14 at the state before the barreling. The four sides on which the ceramic green sheets 10 in contact with the resin layer 15 are stacked are also chamfered to have no burrs and corners.

The chamfered base components 2 are then degreased and fired in a firing process. The base components 2 are degreased in a furnace with a nitrogen atmosphere by increasing the temperature to 700° C., and then fired in a reducing furnace with a nitrogen atmosphere at peak temperatures of 1100 to 1250° C. to be sintered.

FIG. 10C is a cross-sectional view of the base component 2 after firing. The resin layers 15 on the base precursor 13 are burned away in the firing process. The base component 2 thus includes a sintered ceramic portion alone. The four sides of the first surface 7A and the second surface 7B are also chamfered by a predetermined amount by the barreling performed before the firing as indicated by reference numeral E4.

The fired base component 2 is plated by electroless plating or electroplating in a final process to form the external electrodes 3 including plating films. The plating film forms when the plating grows from the exposed end of each internal electrodes 5 on the end faces 8 or the side surfaces 9 to join with the adjacent portions. The plating further joins with the plating film on the surface electrodes 14 to be a continuous plating film. The plating may be a copper plating layer. After the plating, annealing at high temperatures of 600 to 800° C. may be performed to form an alloy at the joint with the internal electrodes 5 containing Ni as a main component. This increases the bonding strength at the joint.

To facilitate mounting by soldering, the plating may include forming multilayer outer plating layers including, for example, a Ni layer and a Sn layer. In the manner described above, the multilayer ceramic capacitor 1a illustrated in FIG. 5A is complete.

As described above, the technique described in the second embodiment eliminates use of ceramic green sheets with various thicknesses and formation of the external electrodes 3 by applying a conductive paste. This reduces the number of manufacturing processes and manufacturing costs. The plating film is formed on the exposed portion of the surface electrodes 14 and the internal electrodes 5 that are thin and undeformable as an underlayer. This allows miniaturization of the components with higher accuracy. This also facilitates the manufacture of capacitors with a small pitch, such as the three-terminal capacitor 1b illustrated in FIG. 5B or an extended multi-terminal capacitor.

The multilayer ceramic capacitor according to one or more embodiments of the present disclosure may be implemented in forms 1 to 3 described below.

(1) A multilayer ceramic electronic component, comprising:
a stack including dielectric layers and internal electrodes alternately stacked on one another;
a surface electrode located on at least one of a first surface or a second surface of the stack; and
an external electrode connecting the surface electrode and the internal electrodes,
wherein the surface electrode is thicker than each of the internal electrodes, and located continuously with a uniform thickness along at least one of the first surface or the second surface of the stack.

(2) The multilayer ceramic electronic component according to (1), wherein
each of the surface electrode and the internal electrodes comprises a ceramic component, and
the surface electrode contains a greater amount of ceramic component than the internal electrodes.

(3) The multilayer ceramic electronic component according to (1), wherein
each of the surface electrode and the internal electrodes comprises a glass component, and
the surface electrode contains a greater amount of glass component than the internal electrodes.

The method for manufacturing multilayer ceramic capacitors according to one or more embodiments of the present disclosure may be implemented in forms 4 to 8 described below.

(4) A method for manufacturing multilayer ceramic electronic components, the method comprising:
stacking a plurality of ceramic green sheets and a plurality of internal electrodes alternately on one another to obtain a stack;
obtaining a multilayer base including a surface electrode and a resin layer protecting the surface electrode on at least one of a first surface or a second surface of the stack;
cutting the multilayer base along a cutting line perpendicular to the multilayer base to obtain base precursors being rectangular;
removing the resin layer in each of the base precursors by firing; and
chamfering an edge of each of the base precursors before firing.

(5) The method according to (4), wherein
the resin layer comprises a resin sheet, and the resin sheet is placed on at least one of the first surface or the second surface of the stack together with the surface electrode when the plurality of ceramic green sheets is stacked.

(6) The method according to (5), wherein
the surface electrode is located on the resin sheet.

(7) The method according to any one of (4) to (6), wherein
an internal electrode of the plurality of internal electrodes located closest to the resin layer is an anchor tab, and an exposed portion of the anchor tab on a side surface, an exposed portion of another internal electrode of the plurality of internal electrodes, and an end of the surface electrode are aligned in a stacking direction.

(8) The method according to (4), wherein
the surface electrode protected by the resin layer in each of the base precursors includes a predetermined electrode pattern, and
the method further comprises connecting the plurality of internal electrodes and the electrode pattern with an external electrode.

In one or more embodiments of the present disclosure, the above multilayer ceramic electronic component and the method for manufacturing multilayer ceramic electronic components allow chamfering of the cut individual components without damaging the electrodes formed on the main surfaces of the multilayer base yet to be cut into the individual components, thus providing small multilayer ceramic electronic components including the surface electrodes with high accuracy.

The present disclosure may be embodied in various forms without departing from the spirit or the main features of the present disclosure. The embodiments described above are thus merely illustrative in all respects. The scope of the present disclosure is defined not by the description given above but by the claims. Any variations and alterations contained in the claims fall within the scope of the present disclosure.

### REFERENCE SIGNS

1 multilayer ceramic capacitor
2 base component
3 external electrode
4 dielectric ceramic body
5 internal electrode
6 protective layer
7A first surface
7B second surface
8 end face
9 side surface
10 ceramic green sheet
11 multilayer base
12 cutting line
13 base precursor
14 surface electrode
15 resin layer
16 resin sheet
18 support sheet
20 feedthrough conductor
22 anchor tab
23 via array capacitor
1b three-terminal capacitor

1. A multilayer ceramic electronic component, comprising:
a stack including dielectric layers and internal electrodes alternately stacked on one another; and
a surface electrode located continuously with a uniform thickness on at least one of a first surface and a second surface of the stack; and being thicker than each of the internal electrodes.

2. The multilayer ceramic electronic component according to claim 1, wherein
the surface electrode
contains a greater amount of a ceramic component than each of the internal electrodes.

3. The multilayer ceramic electronic component according to claim 1, wherein
the surface electrode
contains a greater amount of a glass component than each of the internal electrodes.

4. A method for manufacturing multilayer ceramic electronic components, the method comprising:
preparing a stack including a plurality of ceramic green sheets and a plurality of internal electrodes alternately stacked on one another;
obtaining a multilayer base including a surface electrode and a resin layer covering the surface electrode, the surface electrode and resin layer located on at least one of a first surface and a second surface of the stack;
preparing base precursors being rectangular by cutting;
removing the resin layer in each of the base precursors by a firing; and
chamfering an edge of each of the base precursors before the firing.

5. The method according to claim 4, wherein
the resin layer comprises a resin sheet, and the resin sheet is placed on at least one of the first surface and the second surface of the stack together with the surface electrode when the plurality of ceramic green sheets is stacked.

6. The method according to claim 5, wherein
the surface electrode is located on the resin sheet.

7. The method according to claim 4, wherein
an internal electrode of the plurality of internal electrodes located closest to the resin layer is an anchor tab, and
an exposed portion of the anchor tab on a side surface, an exposed portion of another internal electrode of the plurality of internal electrodes, and an end of the surface electrode are aligned in a stacking direction.

8. The method according to claim 4, wherein
the surface electrode covered by the resin layer in each of the base precursors includes a predetermined electrode pattern, and
the method further comprises connecting the plurality of internal electrodes and the electrode pattern with an external electrode.
